(19) United States
(12) Patent Application Publication
(10) Pub. No.: US 2016/0281812 A1
(43) Pub. Date: Sep. 29, 2016

(54) Thickness Increase Spring

(71) Applicant: Christina Xiaolin DAI, Toronto (CA)

(72) Inventor: Christina XiaoLin Dai, Toronto (CA)

(21) Appl. No.: 14/392,403

(22) PCT Filed: Feb. 25, 2014
(86) PCT No.: PCT/CA2014/000146

§ 371 Date: May 17, 2016

(51) Int. Cl. F16F 1/04; F16F 1/373

(52) U.S. Cl. CPC F16F 1/043; F16F 1/047; F16F 1/373

(57) ABSTRACT

The new springs provide many different levels of accelerate increasing physical force. There are two rules to help you form a new spring. The deflection between two adjacent wire rings always has to be kept linear along the whole spring. First, along the whole spring wire, the (cross section area)⁻² should be linear. Second, along the whole wire, the pitch could adapt linear change. To get different accelerate effects, you need to adjust these constants in the two linear functions of the two rules. The new springs are flexible enough to fit in many places, i.e. in factory lines, in robot end effector, in artificial legs, in giant machines . . . etc.

### BACKGROUND

The industry lines have been calling for a feasible dynamic force to improve the process for years. The machinery are very precise and reliable but not flexible enough. Mostly constant forces are used. The machine's motion is always more clumsy than human beings. Computers can help to provide some flexible solutions but with a big price tag. People tried to make new suspension coil spring with changing gauge and pitch. They didn't come up with rules to regulate the wire diameter and pitch, so far not successful and their spring can't be used at other places other than suspension. Their progressive spring rate is still very close to constant. Now these have all been changed.

To form the new spring, the deflection along the wire should always be linear. The wire should go down through a straight line, while wraps around the coil. Otherwise the spring wire doesn't have a stable base to build up the coil; spring wire will become wavy during compression and won't last long.

The (cross section area)⁻² should be linear along the wire, to guaranty the linear deflection. (see Claim 1, Based on R=Gd⁴/8nD³, R: spring rate, d: wire diameter, G: torsion modulus, D: Coil diameter, n: number of rings. You can say that d⁻⁴ is linear in most case.) (see also FIG. 1). When force applies to press the spring, the deflection happens through the whole spring. The weak end has lower spring rate on each ring. If you add the deflections at each ring, you will get total deflection for the coil. At one point, the weak end starts to stack and become idle, and doesn't contribute to the whole spring's deflection. Hence the spring rate starts to increase. This lasts till the strong end close.

Furthermore, you can adapt a linear pitch to coil the spring (see Claim 2). The down slope of the pitch is preferred to start at the strong end. Since the weak side has less space for the rings to move, these rings will close early than before. This step makes the new spring rate increases early and more obvious, so further improve the usefulness of new springs.

This solves the “set” problem of springs on the weak end, since the gap between adjacent rings is narrow.

### BRIEF DESCRIPTION ABOUT DRAWINGS

FIG. 1: front view of the new spring in free condition.

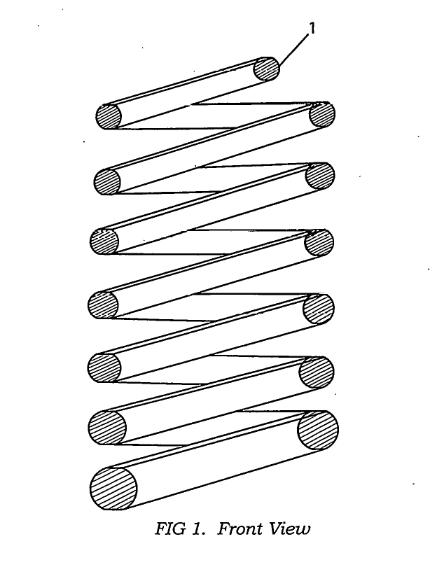

Ref. 1: the cross section of spring wire, in shaded area.

How the new spring rate increases, is calculated as below.

Here I give examples of 5 new springs with different levels increasing rates.
1. First, scale the wire's length to 7 (number of rings); scale the original cross section area to 1. To construct a new spring, you should make the deflection linear. That means the wire cross section area² follow reciprocal curves you choose.

TABLE 1
Area² on wire. (Also serve as segment's maximum force level.)

| Area² on wire | 1 | 2 | 3 | 4 | 5 | 6 | 7 |
|---|---|---|---|---|---|---|---|
| Y₁: 3/(x + 2) | 1 | 0.75 | 0.60 | 0.5 | 0.43 | 0.38 | 0.33 |
| Y₂: 5/(x + 4) | 1 | 0.83 | 0.71 | 0.63 | 0.56 | 0.5 | 0.45 |
| Y₃: 8/(x + 7) | 1 | 0.89 | 0.80 | 0.73 | 0.67 | 0.62 | 0.57 |
| Y₄: 11/(x + 10) | 1 | 0.92 | 0.85 | 0.79 | 0.73 | 0.69 | 0.65 |
| Y₅: 14/(x + 13) | 1 | 0.93 | 0.88 | 0.82 | 0.78 | 0.74 | 0.7 |

i.e., for spring 1, the cross section area²: 1:0.75:0.60:0.5:0.43:0.38:0.33, the forth root value is the wire diameter: 1:0.93:0.88:0.84:0.81:0.785:0.758(= 0.33^{0.25}). If you want a wire diameter start 11 mm at the thick end, it will be 11:10.23:9.68:9.24:8.91: 8.64:8.34(= 0.758 × 11). If the whole spring wire is 1.0 meter long; each ring/segment is 0.14 m(= 1.0 m/7) long.

2. Get the linear deflection of the above mentioned 5 new springs. The numbers are reciprocal value from TABLE1. (R: spring rate, proportion to d⁴ or area², and reverse proportion to deflection.)

TABLE 2
Deflection on wire. (They are in scale and equal area⁻²).

| Deflection | | | | | | | |
|---|---|---|---|---|---|---|---|
| on wire | 1 | 2 | 3 | 4 | 5 | 6 | 7 |
| D₁ | 1 | 1.33 | 1.67 | 2.0 | 2.33 | 2.63 | 3.03 |
| D₂ | 1 | 1.20 | 1.41 | 1.59 | 1.79 | 2.0 | 2.22 |
| D₃ | 1 | 1.12 | 1.25 | 1.37 | 1.49 | 1.61 | 1.75 |
| D₄ | 1 | 1.09 | 1.18 | 1.27 | 1.37 | 1.45 | 1.55 |
| D₅ | 1 | 1.08 | 1.14 | 1.22 | 1.28 | 1.35 | 1.43 |

i.e., for spring 1, deflection for each rings in order: 1:1.33:1.67:2.0:2.33:2.63:3.03. These are proportion to each other.

3. Now , for every ring's maximum force level (TABLE1 in scale), add the deflection data from TABLE2. Only left side rings should be added because they has bigger diameter and still working at the maximum force level for the current segment.

TABLE 3
Active Deflection SUM

| Active seg. | | | | | | | |
|---|---|---|---|---|---|---|---|
| Deflection sum | 1 | 2 | 3 | 4 | 5 | 6 | 7 |
| D_{1ADS} | 1 | 2.33 | 4.0 | 6.0 | 8.33 | 10.96 | 13.99 |
| D_{2ADS} | 1 | 2.20 | 3.61 | 5.2 | 6.99 | 8.99 | 11.21 |
| D_{3ADS} | 1 | 2.12 | 3.37 | 4.74 | 6.23 | 7.84 | 9.59 |
| D_{4ADS} | 1 | 2.09 | 3.27 | 4.54 | 5.91 | 7.36 | 8.91 |
| D_{5ADS} | 1 | 2.08 | 3.22 | 4.44 | 5.72 | 7.07 | 8.5 |

i.e., for spring 1, at maximum force level (0.75, TABLE 1) of seg. 2, 1:1.33, D_{1ADS}(2) = 2.33.
i.e., for spring 1, at maximum force level (0.6, from TABLE 1) of seg. 5, add:1:1.33:1.67:2.0:2.33, you get D_{1ADS}(5) = 8.33.

4. Calculate TABLE4-total deflection=current maxi force level (TABLE1)×act seg.s' deflection (from TABLE3)+retired right side segment (full length)

| Total Deflection at | | | | | | | |
|---|---|---|---|---|---|---|---|
| current maxi force | 1 | 2 | 3 | 4 | 5 | 6 | 7 |
| D_{1Total} | 7.0 | 6.8 | 6.4 | 6.0 | 5.6 | 5.2 | 4.6 |
| D_{2Total} | 7.0 | 6.8 | 6.6 | 6.3 | 5.9 | 5.5 | 5.0 |
| D_{3Total} | 7.0 | 6.9 | 6.7 | 6.5 | 6.2 | 5.9 | 5.5 |
| D_{4Total} | 7.0 | 6.9 | 6.8 | 6.6 | 6.3 | 6.1 | 5.7 |
| D_{5Total} | 7.0 | 6.9 | 6.8 | 6.6 | 6.5 | 6.2 | 5.9 |

i.e., for spring 1, at maximum force level (0.43 in scale, TABLE 1) of segment 5, total deflection 5.6 = 0.43(from TABLE 1) × 8.33(from TABLE 3) + (7-5)

TABLE 5
Put force level and deflection together
The 5 new springs come with different accelerate increasing rates.
Force rows: current segment's maximum force level, data from TABLE 1.
Deflection rows: Total deflection, data from TABLE 4.

| Total deflection at | | | | | | | |
|---|---|---|---|---|---|---|---|
| each Force level | 1 | 2 | 3 | 4 | 5 | 6 | 7 |
| Y₁: force | 1 | 0.75 | 0.60 | 0.50 | 0.43 | 0.38 | 0.33 |
| D_{1Total} | 7.0 | 6.8 | 6.4 | 6.0 | 5.6 | 5.2 | 4.6 |
| Y₂: force | 1 | 0.83 | 0.71 | 0.63 | 0.56 | 0.50 | 0.45 |
| D_{2Total} | 7.0 | 6.8 | 6.6 | 6.3 | 5.9 | 5.5 | 5.0 |
| Y₃: force | 1 | 0.89 | 0.80 | 0.73 | 0.67 | 0.62 | 0.57 |
| D_{3Total} | 7.0 | 6.9 | 6.7 | 6.5 | 6.2 | 5.9 | 5.5 |
| Y₄: force | 1 | 0.92 | 0.85 | 0.79 | 0.73 | 0.69 | 0.65 |
| D_{4Total} | 7.0 | 6.9 | 6.8 | 6.6 | 6.3 | 6.1 | 5.7 |
| Y₅: force | 1 | 0.93 | 0.88 | 0.82 | 0.78 | 0.74 | 0.70 |
| D_{5Total} | 7.0 | 6.9 | 6.8 | 6.6 | 6.5 | 6.2 | 5.9 |

Then draw a chart (x=force level, y=total deflection). The slope⁻¹ on chart is the spot rate. For each springs, the rate increases during compression. The spring rates are always constant before any ring closes. The change between springs is gradual. You can cut-tail to your need by adjust the TABLE1's constant in function.
6. Add Linear Pitch change to calculations.
All steps are the same, except:
   TABLE1 only serves as data for cross section area² on wire;
   For the maximum force level, you need to multiply by the TABLE1′ data below.

TABLE 1′
Linear pitch factor.

| Pitch factor | | | | | | | |
|---|---|---|---|---|---|---|---|
| on wire | 1 | 2 | 3 | 4 | 5 | 6 | 7 |
| slope 1 to 0.7 | 1 | 0.95 | 0.90 | 0.85 | 0.80 | 0.75 | 0.70 |

$$- For the TABLE 4 - total deflection = current maxi force level ( TABLE 1 ) \times Linear Pitch factor ( TABLE {1}^{′} ) \times act {seg}^{′} s deflection ( from TABLE 3 ) + retired right side segment length ( add from TABLE {1}^{′} )$$

| Total Deflection at | | | | | | | |
|---|---|---|---|---|---|---|---|
| current maxi force | 1 | 2 | 3 | 4 | 5 | 6 | 7 |
| D_{1Total} | 5.95 | 5.66 | 5.26 | 4.80 | 4.31 | 3.83 | 3.23 |
| D_{2Total} | 5.95 | 5.74 | 5.4 | 5.03 | 4.57 | 4.07 | 3.53 |
| D_{3Total} | 5.95 | 5.8 | 5.53 | 5.19 | 4.79 | 4.35 | 3.84 |
| D_{4Total} | 5.95 | 5.82 | 5.59 | 5.29 | 4.90 | 4.51 | 4.02 |
| D_{5Total} | 5.95 | 5.83 | 5.64 | 5.34 | 5.03 | 4.63 | 4.16 |

I.e., for spring 1, at maximum force level 0.43, Linear Pitch factor0.8 of segment5, two retired segment length under linear pitch (0.75+0.7).

total deflection 4.31=0.43 (from TABLE1)

×0.8 (from TABLE1′)

×8.33 (from TABLE 3)

+(0.7+0.75) (from TABLE1′)
For the TABLE5, Put new force level with linear pitch adjustment and deflection together. Force Row: TABLE1×TABLE1′

| Total deflection at | | | | | | | |
|---|---|---|---|---|---|---|---|
| each Force level | 1 | 2 | 3 | 4 | 5 | 6 | 7 |
| Y₁: force | 1 | 0.71 | 0.54 | 0.43 | 0.34 | 0.29 | 0.23 |
| D_{1Total} | 5.95 | 5.66 | 5.26 | 4.80 | 4.31 | 3.83 | 3.23 |
| Y₂: force | 1 | 0.79 | 0.64 | 0.53 | 0.45 | 0.38 | 0.32 |
| D_{2Total} | 5.95 | 5.74 | 5.40 | 5.03 | 4.57 | 4.07 | 3.53 |
| Y₃: force | 1 | 0.85 | 0.72 | 0.62 | 0.54 | 0.47 | 0.40 |
| D_{3Total} | 5.95 | 5.80 | 5.53 | 5.19 | 4.79 | 4.35 | 3.84 |
| Y₄: force | 1 | 0.87 | 0.76 | 0.67 | 0.58 | 0.52 | 0.45 |
| D_{4Total} | 5.95 | 5.82 | 5.59 | 5.29 | 4.9 | 4.51 | 4.02 |
| Y₅: force | 1 | 0.88 | 0.79 | 0.70 | 0.63 | 0.56 | 0.49 |
| D_{5Total} | 5.95 | 5.83 | 5.64 | 5.34 | 5.03 | 4.63 | 4.16 |

So if you construct a new spring Y₁ with the cross section area² descend in proportion 1:0.75:0.60:0.5:0.43:0.38:0.33 (1 is the scale of the cross section area² of the thickest segment on spring), coiling to 7 segment, winding with the weak end pitch 0.7 times as wide as the big end, when compression force increase in scale to 0.23:0.29:0.34:0.43:0.54:0.71:1 (1 is the scale for maximum force of the thickest spring ring), the deflection will be in scale to 3.23:3.83:4.31:4.80:5.26:5.66:5.95 (5.95 is the scale for the spring coil total length).

The constants in claim 1 controls the bent of the deflection/force curve, while the constants in claim 2 controls if the curve start to bent early or late. (about 0.3-0.5 of the full length)

The new hot rolling process in the factory will be used to make different new spring bars with heavy gauges. For new light gauge spring, it will have to be cold grinded or shaved from the regular bar to shape. The light gauge spring might cost more money to make, users should check if the higher manufacturing cost worth the effort.

Not only you can get accelerate increasing force, but also you can achieve other types of force through these new springs. By simply putting new spring outside the hydraulic pipe, between the pipe and the object, your force accelerate increases in time. This is because hydraulic pipe has constant speed, speed=distance/time under the limit of the hydraulic pipe. By simply putting new spring inside the hydraulic pipe, to offset the hydraulic force, your force became accelerate decreasing in distance and in time. By simply use a weak conventional spring to offset the new spring force (the point of force is between the new and the old spring), your force decrease accelerate and then accelerate decreasing. By simply deducting the new spring force from a constant weight, the assembly achieves accelerate decreasing force in distance. And with more complicated assembly, you can achieve more complicated forces. Of course, the above mentioned effects come with many levels. So it became useful.

### Usage:

For industry lines, you can achieve better force/stroke. During high speed, the spring will have some noise due to stack. Use rubber pad to avoid noise.
For giant field machines, you might provide human operator better control. (See last chart) Some spring curves allow about 30% or 50% present force adjustment at all most all levels with the same length adjustment. This is the same as the human brain's adjustment nature.
For redesign wide-range robot end effector. Springs allow some angle between end effector and object. The new springs can work on a wide range of load. So the end effect could be more adaptable. If you add a “return assistant” mechanism to the new spring, the new spring will provide better preciseness.
For scientific experiment, you get special or complicated stroke or forces.
Transportation's suspension. It is good to balance comfort and load capacity. It also could be used to maximize the suspension effort with allowable minimum damage to the object.
You can also install it on your dock to park your yacht.

1. To form the new spring, the (wire cross section area)⁻² should be linear along the whole wire.

2. Further to claim 1, the new spring could be coiled with linear pitch.
